(19) United States
(12) Patent Application Publication
(10) Pub. No.: US 2011/0270886 A1
(43) Pub. Date: Nov. 3, 2011

(54) MECHANISM AND APPARATUS FOR TRANSPARENTLY ENABLES MULTI-TENANT FILE ACCESS OPERATION

(75) Inventors: Wen Hao An, Beijing (CN); Chang Jie Guo, Beijing (CN); Bo Gao, Beijing (CN); Zhi Hu Wang, Beijing (CN); Zhe Ma, Beijing (CN)

(73) Assignee: International Business Machines Corporation, Armonk, NY (US)

(21) Appl. No.: 13/097,881

(22) Filed: Apr. 29, 2011

(30) Foreign Application Priority Data
Apr. 30, 2010 (CN) 201010168702.2

(51) Int. Cl. G06F 17/30; G06F 7/00

(52) U.S. Cl. 707/785; 707/705; 707/E17.01

(57) ABSTRACT

The present invention relates to a multi-tenant technology. The disclosure provides a method for processing a file access request to a multi-tenant application by using a file proxy and a corresponding file proxy apparatus, the method comprising: intercepting a file access request; converting the file access request based on a predetermined file isolation model; and transmitting the converted file access request to an operating system. By using this invention, the necessity of modifying a source code of an application so as to enabling a single-tenant application to support an operation in the multi-tenant model may be reduced. The present invention further provides a multi-tenant file system adapted for a multi-tenant application. In cooperation with the multi-tenant system, the method and file proxy apparatus according to the present invention may provide transparent support to fulfill security isolation and access control of tenant files with different SLAs.

### FIELD OF THE INVENTION

The present invention relates to a multi-tenant technology, and more particularly, to a method and an apparatus for processing file access to a multi-tenant application.

### BACKGROUND OF THE INVENTION

Software as a Service (SaaS) provides a multi-tenant application to a software user via a multi-tenant (MT) technology, i.e., running a single instance of an application on a server of a service provider, where the single instance of the application provides a service to multiple tenants (such as organizations of enterprises), which can reduce the costs of development, deployment and running of the software application program.

In a multi-tenant application, an important problem is how to handle the multiple tenants' access to a file system under the condition of satisfying a service level agreement (SLA), which involves aspects of file sharing, security isolation, and upgradability, etc. To enable a single-tenant application (or application program) to support a multi-tenant model, such as file access, a source code of the application needs to be modified.

### SUMMARY OF THE INVENTION

The present inventors have determined that modifying a source code of an application to enable a single-tenant application (or application) to support a multi-tenant model is inherently not a secure action, and likely leaves bugs to be attacked by hackers, making it hard to guarantee absolute security of a tenant file in a multi-tenant model.

Embodiments of the present invention enable a file operation of an application to access a file system to support multi-tenant application without changing original codes of a conventional single-tenant application, so as to transparently support fulfilling a requirement of a file system isolated for security, with diversified SLAs, and upgradability among tenants.

Accordingly, one embodiment of this invention provides enhanced middleware for accessing a file system, and more particularly to leverages the instrument mechanism of a JAVA virtual machine (JVM) to provide a file access interface as provided by a traditional application according to JVM.

According to an embodiment of the present invention, there is provided a method for processing a file access request to a multi-tenant application by using a file agent, comprising the following steps executed by the file proxy: intercepting the file access request; converting the file access request based on a predetermined file isolation model; and

transmitting the converted file access request to an operating system.

According to another aspect of the present invention, there is provided a file proxy apparatus for processing a file access request to a multi-tenant application, comprising:

an intercepting module, for intercepting a file access request; a converting module for routing the file access request based on a predetermined file isolation model which is satisfied the tenant service level agreement (SLA); and a transmitting module for transmitting the converted file access request to an under operating system.

Embodiments of the present invention further provide a multi-tenant file system adapted for a multi-tenant application; this multi-tenant file system is used in cooperation with the method and file proxy apparatus according to embodiments of the present invention and may better support isolation and access control of tenant files that satisfy different SLAs.

### BRIEF DESCRIPTION OF DRAWINGS

Inventive features that are regarded as the characteristics of the present invention are set forth in the appended claims. However, the present invention, its implementation mode, objectives, features and advantages will be better understood by reading the following detailed description of the exemplary embodiments with reference to the accompanying drawings, wherein:

FIGS. 1A and 1B illustrate a file access operation in a multi-tenant application implemented by the prior art;

FIG. 2 illustrates a flowchart of a method for processing a file access request to a multi-tenant application by using a file proxy, according to one embodiment of the present invention;

FIG. 3A illustrates a file system in a folder structure;

FIG. 3B illustrates an MT file system according to one embodiment of the present invention;

FIG. 4 illustrates a flowchart of a method for building an MT file system according to one embodiment of the present invention;

FIG. 5 illustrates an example of an access control list;

FIG. 6 illustrates a mapping between a tenant and a tenant folder;

FIG. 7 illustrates a schematic block diagram according to one embodiment of the present invention;

FIG. 8 illustrates a diagram of a file proxy apparatus; and

FIG. 9 illustrates a diagram of another embodiment of the present invention.

### DETAILED DESCRIPTION OF EMBODIMENTS

Hereinafter, embodiments of the present invention will be described with reference to the accompanying drawings. In the following description, many specific details are illustrated so as to understand the present invention more comprehensively. However, it is apparent to those skilled in the art that the present invention may be implemented without these details. Additionally, it should be understood that the present invention is not limited to the particular embodiments as introduced here. On the contrary, any arbitrary combination of the following features and elements may be considered to implement and practice the present invention, regardless of whether they involve different embodiments. Thus, the following aspects, features, embodiments and advantages are only for illustrative purposes, and should not be understood as elements or limitations of the appended claims, unless otherwise explicitly specified in the claims.

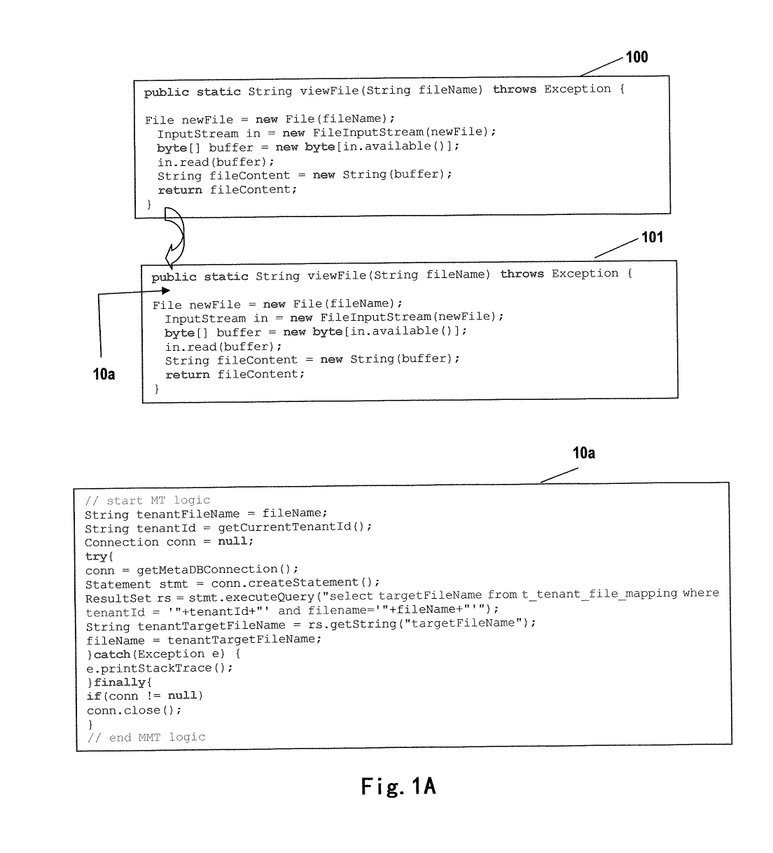

FIGS. 1A and 1B schematically illustrate a file access operation in multi-tenant application implemented in the prior art. As indicated in FIG. 1A, an application program 100 is a part of an application program of an application in a single-tenant model, which has a function of accessing a file with a file name of “fileName” (“viewFile(String fileName)”).

In the single-tenant model, there is no problem of isolating tenant files among multiple tenants. However, in order to support the application program 100 that is available to multiple tenants in a multi-tenant model, a segment of code (also called MT enhancement code 10a) should be added into the application program 100, and therefore the application program 100 is converted into an application program 101 adapted for file access in the MT model.

The MT enhancement code 10a plays a role of obtaining a target file name associated with a tenant for requesting file access from a file name “filename,” for example “tenantTargetFileName,” based on a tenant file isolation model in a multi-tenant model. The logic of the MT enhancement code 10a varies with a tenant file isolation manner.

FIG. 1B illustrates an example of implementing file access of the application program 101 on a service platform in the prior art. As illustrated in FIG. 1B, the service platform comprises a Web Application Server (WAS), a Java Virtual Machine (JVM) deployed on the WAS, an Operating System (OS) and a File System (FS) 110.

An application comprising the application program 101 is deployed on a Web Application Server WAS. Under this deployment, file access of the application program 101 is processed in the following manner.

In Step 111, a tenant (or a user of the tenant) commits a file access request, which file access request comprises a file name. The file access request may further comprise other parameters, for example, access type, etc.

In Step 112, the application program 101 sends a file access request to a JVM, which file access request comprises a target file name.

As depicted above with reference to FIG. 1, a target file name is converted from a file name by the MT enhancement code 10a.

In Step 113, the JVM transmits the file access request to an operating system.

In Step 114, the operating system processes the file access request and returns the processing result to the JVM.

In Step 115, the JVM returns the processing result to the application.

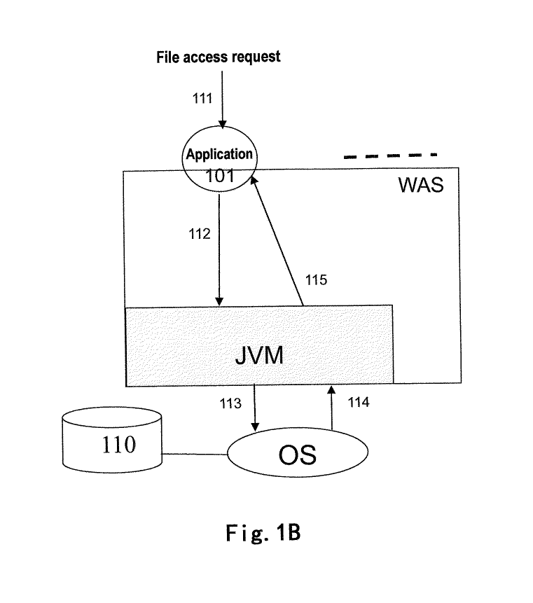

FIG. 2 illustrates an example of implementing file access to the application program 100 on a service platform according to one embodiment of the present invention. The service platform as shown in FIG. 2 is substantially identical to what is illustrated in FIG. 1. The difference is that the application deployed on the Web Application Server WAS comprises the application program 100 before conversion as illustrated in FIG. 1B, and that a file agent or file proxy 20a is deployed on the Java Virtual Machine (JVM).

According to one embodiment of the present invention, under this deployment, file access of the application program 101 is processed in the following manner.

In Step 211, a tenant (or a user of the tenant) commits a file access request; the file access request comprises a file name.

In Step 212, the application program 100 sends a file access request to a JVM; the file access request comprises a file name.

The file agent 20a intercepts this file access request and converts it, for example, converting a file name in the file access request into a target file name.

In Step 213 the file proxy 20a transmits the converted file access request to the operating system.

For example, the JVM calls a method of a file/IO implement class injected with an MT-related logic to interact with an Application Program Interface (API) of the operating system, and to transmit the file access request to the operating system.

In Step 214, the operating system processes the converted file access request and returns the processing result to the JVM.

In Step 215, the JVM returns the processing result to the application.

Compared with the method as illustrated in FIG. 1B, the method of processing a file access request to a multi-tenant application by using a file proxy according to embodiments of the present invention is characterized by comprising the steps of:

Intercepting a file access request;

Converting the file access request based on a predetermined file isolation model; and

Transmitting the converted file access request to an operating system.

According to one embodiment of the present invention, the file proxy 20a is deployed on the JVM. In this case, the file proxy 20a can intercept the file access request in the following manner.

The file agent 20a monitors whether the JVM is to load a file/IO implement class.

A multi-tenant application processes a file access request to the JVM by invoking a file/IO interface using a java code. As a response to the file access request, the JVM should load a file/IO implement class. Those skilled in the art know that the file/IO implement class comprises parameters such as method, property, variable, etc., and the JVM interacts with an application program interface of the operating system so as to operate the file system by the method of file/IO implement class.

According to one embodiment of the present invention, if the file agent 20a monitors that the JVM is to load the file/IO implement class, a file access request conversion logic will be injected into the method of file/IO implement class before the request is to be loaded to the JVM.

Those skilled in the art know this enables the injected file access request conversion logic to perform relevant processing prior to bottom level access.

The injected file access request conversion logic converts the file access request based on a predefined file isolation model.

The manner of converting a file access request varies with a specific implementation, which is particularly relevant to the employed file isolation model.

According to one embodiment of the present invention, a predefined file isolation model may be obtained by the following steps: identifying the file access request of a tenant; obtaining corresponding tenant metadata based on the identification of the tenant; and obtaining a predefined file isolation model from the tenant metadata.

For example, for a user operating the application, the user may be verified by querying the registration information of the tenant, and in case that the user is a verified registered tenant, the tenant identification of the registered tenant, to which the user belongs, is obtained.

Those skilled in the art known that the user is generally verified upon user logon, such that during the session period of the logged user, the tenant identification of the legal user as obtained upon logon is saved. Therefore, whenever the user issues a file access request during the user session period, the tenant identification of the tenant to which it belongs can be obtained.

According to one embodiment of the present invention, the file access request conversion logic converts the file name in the file access request into a target file name based on a predefined file isolation model, and the process may be identical or similar to the MT enhancement code 10a in FIG. 1A. Therefore, a converted file access request is generated. As is apparent to those skilled in the art, the content of the file access request conversion logic is not limited thereto.

According to embodiments of the present invention, the JVM may transmit the converted file access request to an application program interface of the operating system by calling a method of file/IO implement class injected with file access request conversion logic.

According to the embodiments of the present invention, the file access request conversion logic may further determine whether the converted file access request conforms to rights with respect to a target file indicated by a target file name based on an access control list ACL in the tenant metadata.

If the request conforms to the rights, then the converted file access request is transmitted; otherwise, the converted file access request will not be transmitted. For example, if a file access request is to modify a file that is not allowed to be modified, for example, an application-level file, the file access request will not be transmitted to the operating system.

Of course, those skilled in the art know that when operating a file system, the operating system may also refer to the ACL to determine whether to accept a file access request or not. However, an extra advantage of a performance of filtering before transmitting the file access request to the operating system is to potentially save resources of the operating system.

As above mentioned, just as the MT enhancement code 10a, the file access request conversion logic to be injected into the file/IO implement class to be loaded by the JVM by using the file proxy 20a according to embodiments of the present invention is closely related to a file isolation model or manner of a multi-tenant application.

Hereinafter, description is given to an example of a file isolation model capable of being implemented with the above method of processing a file access request to a multi-tenant application by using the file agent according to the present invention.

First, a brief introduction is given to a file structure of an application. The table below is a slice of an application file structure of an exemplary file system.

| | | | Whether it is an |
|---|---|---|---|
| | | | application-level |
| Number | Application | Path | file |
| 1 | CRM | Opt/IBM/Websphere/Profiles/ | Y |
| | | AppSrv01/InstalledApps/Crm/ | |
| | | WEB-INF/* | |
| 2 | CRM | Opt/IBM/Websphere/Profiles/ | N |
| | | AppSrv01/InstalledApps/Crm/ | |
| | | Documents/* | |
| 3 | CRM | Opt/IBM/Websphere/Profiles/ | N |
| | | AppSrv01/InstalledApps/Crm/ | |
| | | Documents/logo.jpg | |
| 4 | CRM | Opt/IBM/Websphere/Profiles/ | Y |
| | | AppSrv01/InstalledApps/Crm/ | |
| | | WEB-INF/web.xml | |
| 5 | SFA | Opt/IBM/Websphere/Profiles/ | Y |
| | | AppSrv01/InstalledApps/Crm/ | |
| | | WEB-INF/* | |
| 6 | SFA | Opt/IBM/Websphere/Profiles/ | N |
| | | AppSrv01/InstalledApps/Crm/ | |
| | | WEB-INF/web.xml | |
| 7 | SFA | Opt/IBM/Websphere/Profiles/ | N |
| | | AppSrv01/InstalledApps/Sfa/ | |
| | | Documents/logo.jpg | |
| 8 | SFA | Opt/IBM/Websphere/Profiles/ | N |
| | | AppSrv01/InstalledApps/Crm/ | |
| | | Images /* | |

Columns in the table from the left to the right schematically list the number of a file, the application to which it belongs, path, and property (for example whether it belongs to an application-level file) in the file system. For example, a file “web.xml” numbered “4” is an application-level file of the application “CRM,” with a path of “Opt/IBM/Websphere/Profiles/AppSrv01/InstalledApps/Crm/WEB-INF/web.xml.” The application-level file belongs to a system file, which generally does not allow users to perform operations such as delete/modify etc.

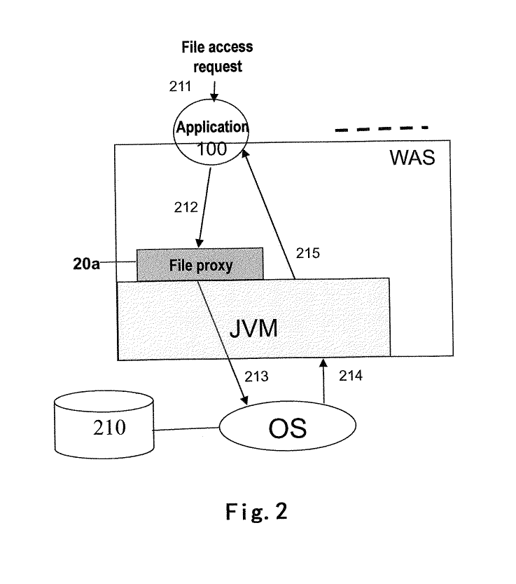

The content in the table may also be indicated in a folder form. A folder is a common file structure. FIG. 3A schematically illustrates a file system 300 in a folder form. For example, as illustrated in the figure, the folder path where the application-level file “web.xml” 30a is located is “Opt/IBM/Websphere/Profiles/AppSrv01/InstalledApps/Crm/WEB-INF/web.xml.” For another example, the folder path where the tenant-level file “a.txt” is located is “Opt/IBM/Websphere/Profiles/AppSrv01/InstalledApps/Crm/Documents/upload.” In a multi-tenant system, a tenant-level file may be isolated in terms of tenant, and different tenants are supported to have different “a.txt” files.

FIG. 3B illustrates an MT file system 310 according to one embodiment of the present invention. As illustrated in the figure, the MT file system 310 comprises an application folder f0 and tenant folders f_T1, f_T2, and f_T3.

As illustrated in FIG. 3B, as the file system 300 in FIG. 3A, the application folder f0 comprises all files of an application, wherein the file “Web.xml” 301 in the subdirectory “WEB-INF” is an application-level file.

The tenant folder f_T1 is a folder for tenant T1. The structure of the tenant folder f_T1 is substantially identical to that of the application folder f0. The difference lies in that according to one embodiment of the present invention, the file “Web.xml” in the tenant folder f_T1 is a link directed to the file “Web.xml” in the application file folder f0, as indicated in the dotted line 312 in the figure.

Similarly, tenant folders f_T2 and f_T3 are a folder for tenant T2 and a folder for tenant T3, respectively, which respectively comprise an application-level file “Web.xml” indicated as a link.

This figure also illustrates that in the example, the application folder f0 and the tenant folder f_T3 are located on a separate physical disk, respectively, for example, on a diskette; while the tenant folder f_T1 and tenant folder f_T2 share a physical disk.

According to one embodiment of the present invention, the file system 210 as illustrated in FIG. 2 may be implemented with an MT file system 310.

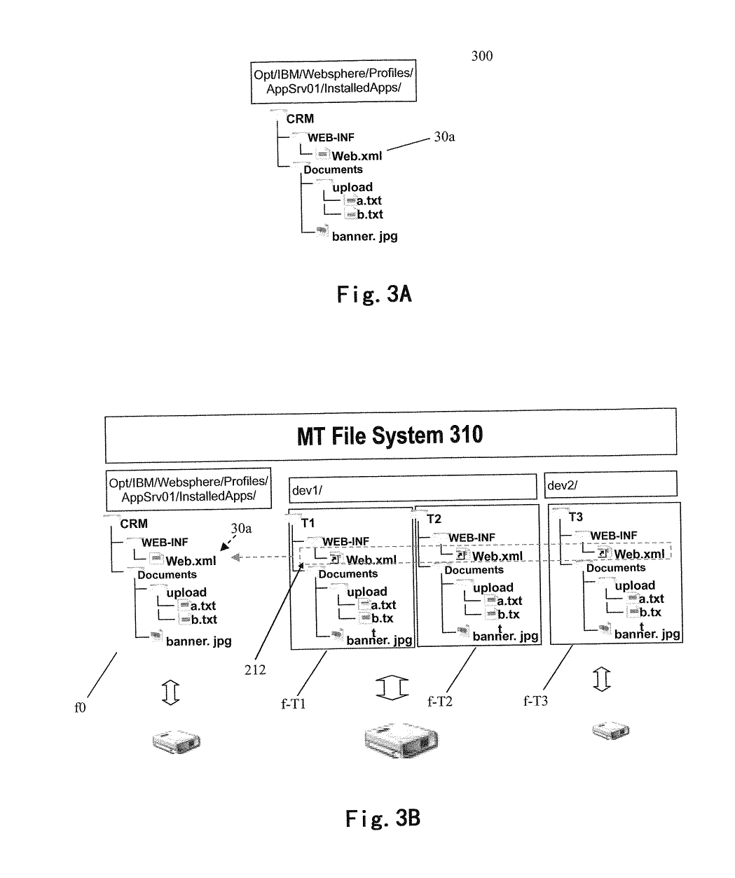

Hereinafter, a building process of the MT file system 310 is illustrated with reference to the flowchart of FIG. 4.

The MT file system 310 according to embodiments of the present invention comprises an application folder and a tenant folder. According to embodiments of the present invention, before a tenant folder is created, a structure of an existing file system may be analyzed first and an application folder for a multi-tenant application may be built, which may be performed manually or with an existing file structure analyzer. The file structure analyzer can analyze a structure of a given file system, for example, a path of each file, from which a multi-tenant application to which each file belongs may also be analyzed out. Therefore, an application folder corresponding to a multi-tenant application is constructed.

According to the embodiments of the present invention, a file structure analyzer may further identify an application-level file in an application folder. In fact, when a developer performs designing and programming to an application, whether a file belongs to an application-level file or not may be properly flagged. In this way, the file structure analyzer may easily recognize or identify the application-level file according to such a flag.

Building the MT file system 310 may be performed in response to a request by a tenant for subscribing to and using a multi-tenant application. In summary, it comprises the following processes:

Analyzing a file system of a multi-tenant application, and building an application folder for a multi-tenant application;

Setting a tenant-specific tenant folder based on an SLA and application folder for each tenant; and copying the selected file from the application folder to the tenant folder;

Saving the application folder name and a mapping relationship between the tenant and the tenant folder in multi-tenant metadata.

FIG. 4 illustrates a more detailed embodiment implementing the above process. As illustrated in the figure, at step 401, a tenant folder for the tenant is set based on the SLA of the tenant. What is directed to by the tenant's folder is a multi-tenant application subscribed to by the tenant and is dedicate to the tenant.

The SLA prescribes a service level provided to fulfill a particular requirement of the tenant. Generally, the SLA may be provided or defined when a new tenant subscribes to use one multi-tenant application, and the SLA may be saved in the metadata of the tenant.

According to one embodiment, data volume of the tenant folder may be set based on the SLA.

According to one embodiment of the present invention, a physical location where the tenant folder is located may be assigned based on the SLA, which location may be a physical medium shared with other tenants or a physical medium dedicated to the tenant, for example, a high speed diskette, etc.

At step 403, a file in a multi-tenant application folder is copied to the tenant folder. It may copy a selected file, for example, an application-level file; a tenant-specific file; or a pre-build file which may be modified by the tenant, for example a customized configuration file.

According to one embodiment, if the selected file is an application-level file, only a link directed to a file of a multi-tenant application folder is established in the tenant folder.

At step 405, an access control list (ACL) of the tenant folder is established, wherein the ACL prescribes access rights to the file. For example, it is prescribed in the ACL that the tenant only performs read operation to an application-level file of a link in the tenant folder.

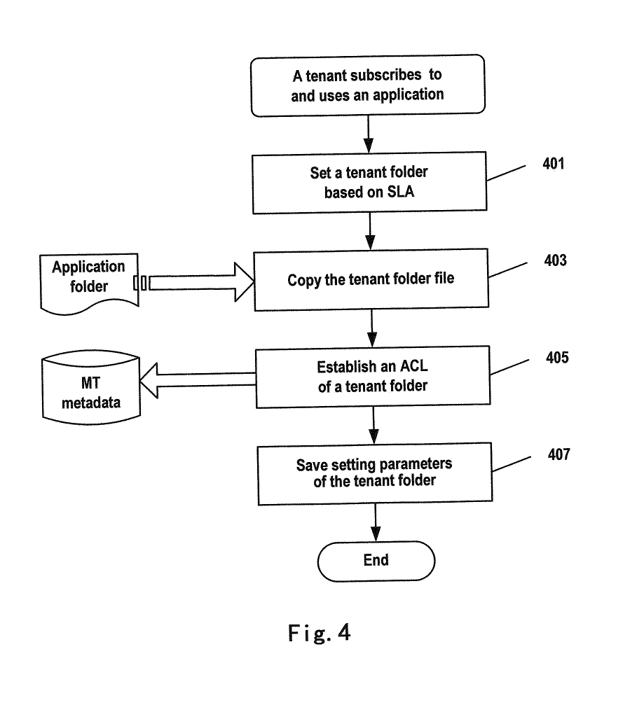

FIG. 5 schematically illustrates examples of some ACLs in the form of a list. For example, the tenant account of T1 is “abc”, which tenant may access the tenant folder dev1_Crm and the tenant folder dev1/T1_Sfa, but can only perform a read operation, instead of modify or delete operations to the specific files “dev1/T1_Crm/WEB-INF/web.xml” and “dev1/T1_Sfa/WEB-INF/web.xml” in the respective folders.

According to one embodiment of the present invention, a tenant account may be created for a tenant in an operating system, and access privilege to a file in the tenant folder may be granted to a tenant account.

Returning to FIG. 4, at step 407, setting parameters of the tenant folder are saved in the multi-tenant metadata. As mentioned above, setting parameters include saving a mapping relationship between a tenant and a tenant folder, for example.

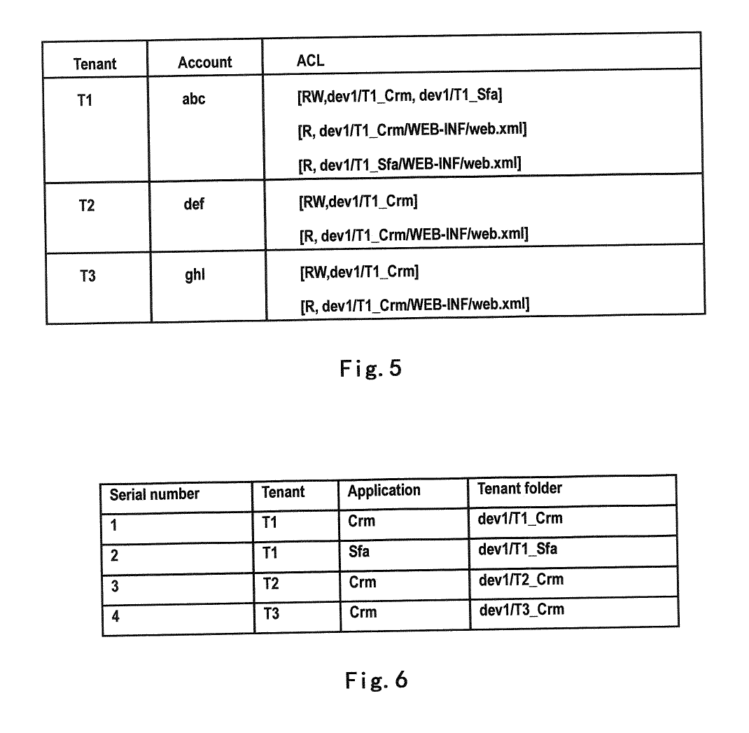

A mapping relationship between a tenant and a tenant folder may be indicated by a tenant folder list as illustrated in FIG. 6. For example, the row numbered 1 in the table of FIG. 6 indicates that the tenant folder is “dev1/T1_Crm” when the tenant “T1” is using the application “Crm.”

The access control list ACL of files of a tenant folder is saved in a multi-tenant metadata, wherein it is defined that the tenant can only perform read operation to an application-level file of a link in the tenant folder.

According to one embodiment, the following configuration parameters and data regarding the MT file system may also be saved in the multi-tenant metadata, for example, data volume of the tenant folder and/or final assigned location of the tenant folder; name of a application folder, tenant account and password for accessing a file, which is file access rights set for preventing the tenant from directly logging on to the operation system operation file.

The result of the above operation is to generate an MT file system 310 as illustrated in FIG. 3B.

In the MT file system of the present invention, the application folder integrally saves all files, thereby guaranteeing the integrity. However, tenant folders linked inside, for example, tenant folders f_T1, f_T2, and f_T3 respectively corresponding to tenants T1, T2, and T3 in the MT file system 210, form three independent sub-file systems that are accessible through an operating system. In a specific embodiment, a tenant folder may be embodied as a diskette or a folder on the diskette. Because a tenant folder is an independent sub-file system, which is individually accessible, the operating system may process the file access request with respect to the tenant folder through the ACL in the tenant metadata, for example, executing read/write operation to files in the tenant folder, or prevent executing modify or delete operations to some files.

A method for file access to a multi-tenant application according to embodiments of the present invention has been described above, and it should be noted that the above depiction is only exemplary and not intended to limit the present invention. In other embodiments of the present invention, this method may have more or less or different steps, and sequences between respective steps may also be different from what is described. For example, in some embodiments of the present invention, the above one or more optional steps may be omitted. Specific embodiments of each step may be different from the depiction. All these variations fall within the spirit and scope of the present invention.

According to the same inventive concept, the present invention further provides a file proxy apparatus for processing a file access request to a multi-tenant application.

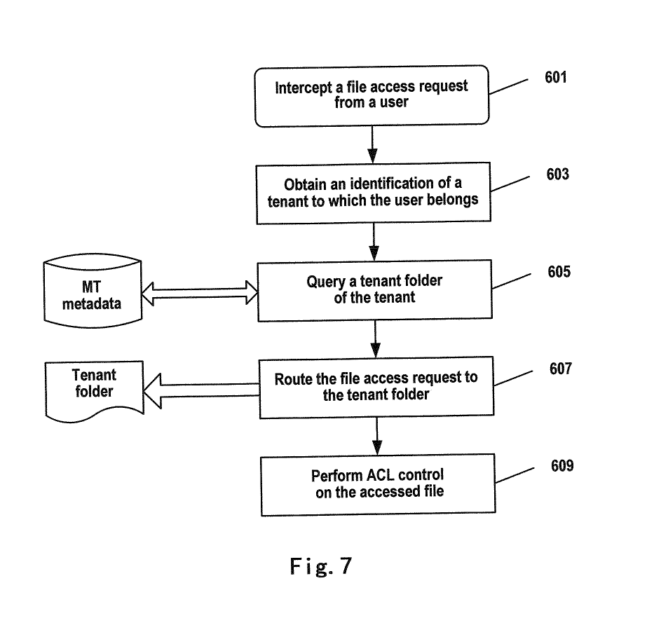

Hereinafter, a file proxy apparatus for file access to a multi-tenant application according to one embodiment of the present invention will be depicted with reference to FIG. 7.

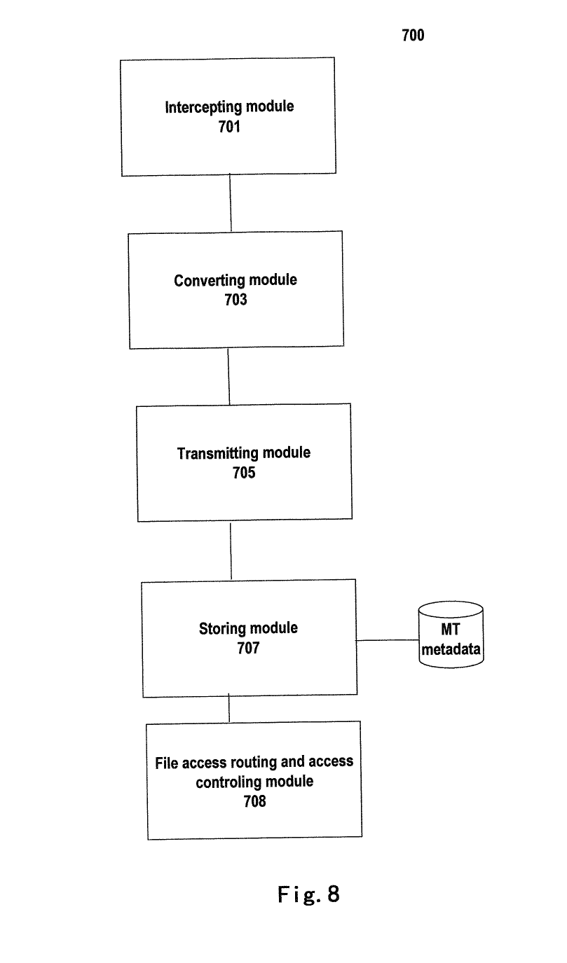

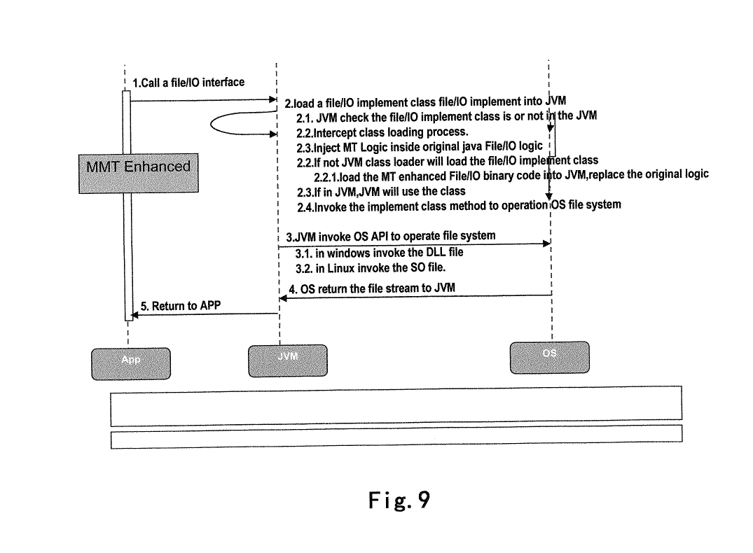

As illustrated in FIG. 8, the file proxy apparatus 700 comprises: an intercepting module 701, a converting module 703, and a transmitting module 705, wherein the intercepting module 701 is for intercepting a file access request; a converting module 703 is for converting the file access request based on a predetermined file isolation model; and a transmitting module 705 is for transmitting the converted file access request to an operating system.

According to one embodiment of the present invention, the intercepting module 701 comprises: monitoring means and injecting means. The monitoring means 712 monitors whether or not a JVM is to load a file/IO implement class in response to a file access request transmitted from a multi-tenant application by calling a file/IO interface. The injecting means injects a file access request conversion logic to a file/IO implement class to be loaded by the JVM when the JVM is to load the file/IO implement class based on a monitoring result of the monitoring means.

According to one embodiment of the present invention, the converting means 703 converts a file access request based on a predetermined file isolation model by using a method of file/IO implement class injected with file access request conversion logic.

According to one embodiment of the present invention, the transmitting module 705 comprises a call module for transmitting the converted file access request to an application program interface of the operating system by calling a method of file/IO implement class injected with a file access request conversion logic.

According to one embodiment of the present invention, the file proxy apparatus 700 may further comprise: an identification module for identifying an identification of a tenant issuing a file access request; and an obtaining module for obtaining corresponding tenant metadata based on the identification of the tenant so as to obtain a predetermined file isolation model from the tenant metadata.

As those skilled in the art should understand, in the file proxy apparatus 700, the identifying module and obtaining module may be individually configured, cooperating with other functional modules, or be integrated with other modules, for example, as a part of the converting module 703. In order to highlight the essence of the embodiments of the present invention, the identifying module and obtaining module are not explicitly marked in the figure.

According to one embodiment of the present invention, the converting module 703 further converts a file name in the file access request into a target file name based on a predetermined file isolation model obtained by the obtaining module, to thereby obtain the converted file access request.

According to one embodiment of the present invention, the file proxy apparatus 700 may further comprise an access control module, for determining, based on an access control list ACL in the tenant metadata, whether or not the converted file access request conforms to rights with respect to a target file indicated by a target file name. Based on the determined result of the access control module, the transmitting module 705 only transmits the converted file access request conforming to the respective access control rights.

As those skilled in the art should understand, in the file proxy apparatus 700, the access control module may be individually configured, cooperating with other functional modules, or be integrated with other modules, for example, as a part of the converting module 730. In order to highlight the essence of the embodiments of the present invention, the indication of the access control module is omitted in the figure.

According to embodiments of the present invention, in the predetermined file isolation model involved in the operation of the file proxy apparatus 700, a tenant of a multi-tenant application has a dedicated folder, and multi-tenant metadata comprise configuration parameters of the tenant folder.

According to one embodiment of the present invention, a dedicated folder for the above tenant may be established in the following manner: analyzing a file system of a multi-tenant application, and building an application folder for the multi-tenant application; setting a tenant-specific tenant folder based on SLA and application folder for the tenant, copying the selected file from the application folder to the tenant folder; and saving a name of the application folder and a mapping relationship between the tenant and the tenant folder in the multi-tenant metadata.

The file proxy apparatus 700 and various kinds of its embodiments have been depicted for implementing the above mentioned method for processing file access to a multi-tenant application according to various embodiments of the present invention. For the sake of simplicity, in the above depiction on the file proxy apparatus 700 and various kinds of its embodiments, some content repetitive to the above depiction on the corresponding method is omitted. Therefore, details of this apparatus may be understood with reference to the above depiction on the corresponding method. Therefore, the above depiction and diagrams on the file proxy apparatus 700 and its various embodiments are only exemplary, and are not limiting of the present invention. In other embodiments of the present invention, this apparatus may have more or less or different modules, and connection or inclusive relationship between respective modules may also be different from what is depicted and illustrated.

The present invention may be implemented by hardware, software, or combinations of hardware and software. The present invention may be implemented in a computer system in a collective or distributive manner, where in the distributive manner, different parts are distributed in a plurality of interconnected computer system. Any computer system or other apparatus suitable for implementing the method as depicted herein is suitable. A typical combination of hardware and software may be a general purpose computer system with a processor, memory, and a computer program. When the program is loaded onto the memory and executed by the processor, it controls the computer system to implement the method of the present invention and constitute the apparatus of the present invention.

The present invention may also be embodied in the computer program product which comprises a tangible computer-readable storage medium with program instructions encoded thereon comprising all features capable of implementing the method as depicted herein and may implement the method when loaded to the computer system.

Although the present invention has been specifically illustrated and explained with reference to the preferred embodiments, those skilled in the art should understand various changes thereto in form and details may be made without departing from the spirit and scope of the present invention.

What is claimed is:

1. A method of processing a file access request to a multi-tenant application by using a file agent, comprising the following steps executed by the file agent:
intercepting the file access request;
converting the file access request based on a predetermined file isolation model;
transmitting the converted file access request to an operating system.

2. The method according to claim 1, wherein the file agent is a file proxy on a Java Virtual Machine JVM, and the step of intercepting a file access request comprises:
in response to monitoring and finding that the JVM is to load a file/IO implement class, injecting file access request conversion logic into a method of the file/IO implement class to be loaded; wherein the JVM is to load the file/IO implement class, in response to the multi-tenant application transmitting a file access request to the JVM by calling a file/IO interface.

3. The method according to claim 2, wherein the method of the file/IO implement class injected with the file access request conversion logic converts the file access request based on a predetermined file isolation model.

4. The method according to claim 3, wherein the step of transmitting the converted file access request to an operating system comprises:
the method of the file/IO implement class injected with the file access request conversion logic transmitting the converted file access request to an application program interface of the operating system.

5. The method according to claim 1, further comprising the steps of:
identifying an identification of a tenant issuing a file access request;
obtaining a corresponding tenant metadata based on the identification of the tenant;
obtaining a predetermined file isolation model from the tenant metadata.

6. The method according to claim 5, wherein converting the file access request comprises converting a file name in the file access request into a target file name based on the obtained predetermined file isolation model, thereby obtaining the converted file access request.

7. The method according to claim 6, further comprising:
based on an access control list ACL in the tenant metadata, determining whether the converted file access request conforms to rights with respect to a target file indicated by the target file name, and the step of transmitting the converted file access request to the operating system comprises only transmitting the converted file access request that conforms to the rights.

8. The method according to claim 1, wherein based on the predetermined file isolation model, a tenant of a multi-tenant application has a dedicated folder, and multi-tenant metadata comprise configuration parameters of the tenant folder.

9. The method according to claim 8, wherein the dedicated folder for the tenant is established by:
analyzing a file system of a multi-tenant application, and building an application folder for a multi-tenant application;
setting a tenant-specific tenant folder based on a tenant SLA and the application folder, and copying a selected file from the application folder to the tenant folder; and
saving a name of the application folder and a mapping relationship between the tenant and the tenant folder in a multi-tenant metadata.

10. The method according to claim 9, wherein the selected file comprises at least one of: an application-level file; a tenant-specific file; and a pre-generated file which may be modified by the tenant.

11. The method according to claim 9, further comprising: saving in the multi-tenant metadata an access control list ACL of an application-level file in the tenant folder, which prescribes that the tenant can only perform read operation to the application-level file of a link in the tenant folder.

12. The method according to claim 9, wherein the configuration parameters comprise at least one of: data volume of the tenant folder and a final location assigned to the tenant folder.

13. A file proxy apparatus for processing a file access request to a multi-tenant application, comprising:
an intercepting module for intercepting a file access request;
a converting module for converting the file access request based on a predetermined file isolation model; and
a transmitting module for transmitting the converted file access request to an operating system.

14. The file proxy apparatus according to claim 13, wherein the intercepting module comprises:
monitoring means for monitoring whether a JVM is to load a file/IO implement class in response to a multi-tenant application transmitting a file access request to the NM by calling a file/IO interface;
injecting means for injecting file access request conversion logic into a method of the file/IO implement class to be loaded based on a monitoring result of the monitoring means.

15. The file proxy apparatus according to claim 14, wherein the converting apparatus converts the file access request by using the method of a file/IO implement class injected with the file access request conversion logic, based on a predetermined file isolation model.

16. The file proxy apparatus according to claim 15, wherein the transmitting module comprises:
a calling module for calling the method of the file/IO implement class injected with the file access request conversion logic to transmit the converted file access request to an application program interface of the operating system.

17. The file proxy apparatus according to claim 13, further comprising:
an identifying module for identifying an identification of a tenant that issues the file access request; and
an obtaining module for obtaining a corresponding tenant metadata based on the identification of the tenant and obtaining a predetermined file isolation model from the tenant metadata.

18. The file proxy apparatus according to claim 17, wherein the converting module further converts a file name in the file access request into a target file name based on the obtained predetermined file isolation model, thereby obtaining the converted file access request.

19. The file proxy apparatus according to claim 17, further comprising an access control module for determining whether the converted file access request conforms to rights with respect to a target file indicated by a target file name, based on an access control list ACL in the tenant metadata, and the transmitting module only transmits a converted file access request that conforms to the rights.

20. The file proxy apparatus according to claim 13, wherein based on the predetermined file isolation model, a tenant of a multi-tenant application has a dedicated folder, and multi-tenant metadata comprises configuration parameters of the tenant folder.

21. The file proxy apparatus according to claim 20, wherein the dedicated folder for the tenant is established by:
analyzing a file system of a multi-tenant application, and building an application folder for the multi-tenant application;
setting a tenant-specific tenant folder based on a tenant SLA and the application folder, and copying a selected file from the application folder to the tenant folder;
saving in multi-tenant metadata a name of the application folder and a mapping relationship between the tenant and the tenant folder.
